(19) United States
(12) Patent Application Publication
(10) Pub. No.: US 2007/0026260 A1
(43) Pub. Date: Feb. 1, 2007

(54) Granular recording medium for perpendicular recording and recording apparatus

(75) Inventors: Hiroaki Nemoto, Kanagawa (JP); Yuzuru Hosoe, Tokyo (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/494,154

(22) Filed: Jul. 26, 2006

(30) Foreign Application Priority Data
Jul. 26, 2005 (JP) 2005-215625

(51) Int. Cl. G11B 5/66

(52) U.S. Cl. 428/831; 428/830

(57) ABSTRACT

A double-layer perpendicular magnetic recording medium suitable for high density recording is obtained. In one embodiment, a granular recording medium is formed on a undercoating layer, in which a first metal composed of Pt, Pd, or an alloy thereof and a second metal composed of Cr or V are included and their composition is 15%<B/(A+B)<30% when the atomic fraction of the first metal is assumed to be A and the atomic fraction of the second metal is assumed to be B.

### CROSS-REFERENCES TO RELATED APPLICATIONS

This application claims priority from Japanese Patent Application No. JP2005-215625, filed Jul. 26, 2005, the entire disclosure of which is incorporated herein by reference.

### BACKGROUND OF THE INVENTION

The present invention relates to a magnetic recording device which magnetically records with high density, saves, and reads information, and to a magnetic recording medium which is used in the magnetic recording device.

One way to achieve high density magnetic recording is to make the magnetic particles smaller, which are the units of magnetic reversal in the magnetic recording layer used for the magnetic recording medium. Moreover, in recent years, a perpendicular magnetic recording method which is understood to be principally advantageous for achieving high density has begun to be adopted over conventional longitudinal magnetic recording methods.

In this regard, the hard magnetic material to which attention is being paid as a material for the magnetic recording layer is a material in which an oxide or a nitride, etc. is added to a CoPt base alloy. A CoPt base alloy shows strong perpendicular magnetic anisotropy when it is deposited by using a common sputtering technique, so that it is a material suitable for a perpendicular magnetic recording method. If an oxide and a nitride which are nonmetallic materials are added to this material, the CoPt alloy film starts to exhibit a granular crystal structure composed of crystalline grains with a diameter of 10 nm or less in which the additives create grain boundaries, resulting in magnetic properties being obtained which are suitable for a high density magnetic recording. This structure is called a granular structure, and a magnetic recording layer having this structure is generally called a granular recording medium.

Originally, a granular recording medium was proposed as a magnetic film in which fine magnetic crystal particles of Fe were dispersed in a non-magnetic matrix composed of SiO₂ (Appl. Phys. Lett., vol. 52, p. 512, 1988). Since the magnetic particles are separated by non-magnetic oxide phases, the magnetic interaction between magnetic grains is weak and fine magnetic crystal grains make it possible to achieve a low noise magnetic recording. However, thermal demagnetization phenomena were quite noticeable and satisfactory performance characteristics as a high recording density medium could not be obtained.

Subsequently, materials and manufacturing methods were proposed to prepare a granular recording medium having a large magnetic anisotropy energy. In JP-A No. 311929/1995, a method is disclosed in which a CoPt base alloy is used as a material for the magnetic particles and the exchange coupling between magnetic grains are eliminated by adding an oxide material such as Al₂O₃, TiO₂, ZrO₂, and Y₂O₃ in addition to SiO₂ as a non-magnetic grain boundary material. In addition to an oxide, a method using a nitride is also disclosed. A reactive sputtering technique using Ar gas, etc. including oxygen or nitrogen may be applied to the deposition of a granular film. Moreover, methods for making further increases in the magnetic isotropic energy are proposed including, for instance, a vacuum annealing after depositing a film (JP-A No. 98835/1995) and the application of RF bias sputtering (JP-A No. 45073/1996), etc.

In the case of applying a CoPt base alloy to a perpendicular magnetic recording method, perpendicular magnetic anisotropy can be obtained by pointing the c-axis of a hexagonal closed packed (hcp) structure of a CoPt base alloy to the direction perpendicular to the film surface. For this, it is preferable that a granular recording medium be deposited on an undercoating layer having the same hcp structure or on an undercoating layer having a face centered cubic (fcc) structure. In JP-A No. 77122/2003 and JP-A No. 346334/2003, materials such as Ti, Ru, Re, Os (hcp structures), Cu, Rh, Pd, Ag, Ir, Pt, Au, Ni (fcc structures), and alloys thereof are disclosed as the candidates. However, actually, a material which is easily oxidized among these materials causes surface oxidation during deposition of a granular medium, so that noble metals (Pt, Pd, Ru, and Au, etc.), which are chemically inactive, are effective as base materials of a granular medium.

IEEE Trans. Magn., vol. 36, p. 2393 and vol. 38, p. 1976, etc. discloses that large coercivities and excellent recording performance can be obtained when an undercoating layer composed of Ru or mainly composed of Ru is used for a CoCrPt—SiO₂ granular magnetic recording layer in which SiO₂ is added to a CoCrPt alloy, above all undercoating layer materials. A remarkable improvement in the recording characteristics becomes possible compared with a conventional perpendicular magnetic recording medium due to the combination of a granular recording medium and a Ru undercoating layer.

For additional disclosures, see JP-A No. 311929/1995, JP-A No. 98835/1995, JP-A No. 45073/1996, JP-A No. 77122/2003, JP-A No. 346334/2003, JP-A No. 327006/2004, US2003-108776, US2004-191571, Appl. Phys. Lett., vol. 52, p. 512, 1988, IEEE Trans. Magn., vol. 36, p. 2393, 2000, and IEEE Trans. Magn., vol. 38, p. 1976, 2002.

### SUMMARY OF THE INVENTION

The reason why Ru has especially excellent performance as an undercoating layer is that the melting point of Ru is about 2500° C. which is relatively high among the aforementioned noble metals and the grain diameters of a polycrystalline film fabricated by a sputtering technique are smaller than those of other metallic films. The grain diameter of a Ru undercoating layer is decreased to the crystal grain size of the CoCrPt alloy in the granular recording medium, resulting in the formation of grain boundaries of the granular recording layer being promoted and excellent recording performance being obtained.

However, it is comparatively difficult for Ru to orient the c-axis of its hcp structure perpendicular to the film surface, so that, in order to obtain the most excellent recording performance using a Ru undercoating layer, it is necessary to control the thickness of the undercoating layer to be several tens of nanometers and to improve the perpendicular orientation of the c-axis. The perpendicular magnetic recording medium has a structure in which a soft-magnetic underlayer is provided at the substrate side as seen from the recording magnetic film, and an increase of the recording density according to an increase in the recording magnetic field and the recording magnetic field gradient becomes possible by making the distance between the recording magnetic film and the soft-magnetic underlayer smaller. Therefore, it is necessary that the thickness of the undercoating layer provided between the recording magnetic film and the soft-magnetic underlayer be made as thin as possible, and the characteristics of the aforementioned Ru become a technical limitation to making the magnetic recording apparatus high density.

On the other hand, Pt and Pd which are noble metals having fcc structures have excellent perpendicular orientation of the [111] direction compared to that of the c-axis direction of Ru, and Pt and Pd undercoating layers can have sufficient crystallographic orientation only with a thickness of several nanometers. Therefore, thin Pt and Pd undercoating layer are thought to be effective in improving the crystallographic orientation of the granular recording medium. However, these materials have lower melting points compared with Ru. The melting point of Pt is 1773° C. and the melting point of Pd is 1554° C. Therefore, since the grain diameter of a polycrystalline film deposited by using a sputtering technique, etc. becomes greater and the formation of grain boundaries of the granular recording medium is prohibited, it is difficult to obtain magnetic characteristics suitable for high density recording.

For a double-layered perpendicular recording medium which has a granular recording medium composed of a CoPt base alloy and a soft-magnetic layer, it is preferable that a noble metal (Pt, Pd) undercoating layer in which the [111] direction of the fcc structure can be easily oriented in the direction perpendicular to the film surface be applied and that the crystallographic orientation of the magnetic recording film be controlled keeping the undercoating layer as thin as possible. However, since the grain diameter of the polycrystalline undercoating layer composed of these low melting point elements becomes greater, growth of the grain boundaries in a granular recording medium formed on this undercoating layer is prevented and it was difficult to obtain magnetic characteristics suitable for high density recording compared with the Ru undercoating layer.

In the present invention, the crystal growth of nano-crystals formed in an undercoating layer is prevented by adding an appropriate amount of Cr or V elements to the undercoating layer mainly composed of Pt, Pd, or an alloy thereof and the grain diameter of a undercoating layer is almost matched to the crystal grain size of a granular recording medium, thereby solving the aforementioned problems.

In accordance with an aspect of the present invention, a perpendicular magnetic recording medium of the present invention comprises a substrate, a perpendicular magnetic recording layer having a granular structure (hereinafter, it is called a granular recording medium) consisting of ferromagnetic nanocrystalline grains and non-magnetic grain boundaries surrounding them, a soft-magnetic underlayer formed between the perpendicular magnetic recording layer and the substrate, and an undercoating layer formed between the soft-magnetic underlayer and the perpendicular magnetic recording layer, in which the undercoating layer contains a first metal selected from a group of Pt and Pd and a second metal selected from a group of Cr and V, with its composition being 15%<B/(A+B)<30% when the atomic fraction of the first metal is assumed to be A and the atomic fraction of the second metal is assumed to be B.

Adding the second metal prevents crystal growth within an alloy underlayer mainly composed of the first metal resulting in the average grain diameter in the alloy undercoating layer to be decreased corresponding to the amount of the added second material. In the case where the second metallic element is added in the aforementioned composition range, the crystal grain size of the alloy undercoating layer is in near agreement with the crystal grain size (almost 5 nm to 7 nm) of the granular recording medium, and there is a favorable formation of grain boundaries composed of a non-magnetic material such as an oxide, etc. in the granular recording medium fabricated on the alloy undercoating layer. At the same time, nano-crystals composed of a magnetic alloy in the granular recording medium are easy to grow epitaxially on the undercoating layer and the crystallographic orientation of the granular recording medium is improved.

In a perpendicular magnetic recording medium fabricated by forming a granular recording medium on the alloy undercoating layer which is within the composition range, the recording performance measured by the magnetic recording head is remarkably improved and the thermal stability is improved by an increase in the coercivity of the recording layer, as compared with a perpendicular magnetic recording medium in which a granular recording medium is formed on an undercoating layer composed of only a first metal to which a second metallic element is not added. Then, it is possible to obtain a magnetic recording medium suitable for a high density magnetic recording medium. In the case where the amount of the added second metallic element is less than the composition range, the grain diameter of the alloy undercoating layer is not made sufficiently fine and the match to the crystal grain side of the granular recording medium is not adequate, so that it is difficult to obtain the excellent recording performance that the granular recording medium might originally have. On the other hand, in the case where the amount of the added second metallic element is greater than the composition range, the grain diameter of the alloy undercoating layer becomes extremely fine and the fcc crystal structure that the first metal originally had is practically deteriorated, so that the crystallographic orientation of the magnetic grains in the granular recording medium deposited thereon is extremely deteriorated. Therefore, the recording performance of the granular recording medium are greatly deteriorated.

The first metal is preferably composed of Pt. In the case of an alloy undercoating layer in which Pt is used as the first metal, the coercivity of the magnetic recording medium of the present invention reaches a maximum and the recording performance (signal to noise ratio, etc.) exhibits the most excellent values. It is thought that the effect of reducing the grain diameter due to the second metallic element is easily brought about since Pt as a pure metal originally has a higher melting point than Pd and it has properties such that the crystal grain size is easily made smaller.

The second metal is preferably composed of Cr. In the case when Cr elements are added to the first metal, the deterioration of the crystallographic orientation of the first metal element is smaller compared with the case of the same amount of V element being added therein. Additionally, since a Cr element is a material having corrosion resistance and contributes to the improvement of corrosion resistance of the magnetic recording medium, it is particularly preferable as a material of the second metallic element.

It is preferable that the thickness of the alloy undercoating layer be 1 nm or more and 20 nm or less. The alloy undercoating layer easily forms an excellent fcc structure even in a thin condition, but it becomes difficult to obtain a [111] crystallographic orientation when the thickness is less than 1 nm. Moreover, the formation of crystal grains in the undercoating layer becomes inadequate, so that it is impossible to obtain the effect of promoting grain boundary formation in the granular recording medium. On the other hand, the surface roughness of the alloy undercoating layer becomes greater when the film thickness grows too much. Therefore, in the case of applying it to the magnetic recording medium, problems arise where, for instance, the flying performance of the magnetic recording head is extremely deteriorated and head crash, etc. occurs, and it is not desirable.

Moreover, if it is necessary, a second undercoating layer using Ru or an alloy mainly composed of Ru may be provided between the alloy undercoating layer and the perpendicular magnetic recording layer having a granular structure. Since the alloy layer has an fcc structure and the [111] direction is oriented in the direction perpendicular to the film surface, even if the film thickness is relatively thin, the c-axis of Ru layer formed thereon is easily oriented to the direction perpendicular to the film surface, so that the problem of the crystallographic orientation of the Ru film being low is solved. In addition, since the grain size of the alloy undercoating layer is made fine and almost matches the crystal grain size of the second undercoating layer, the formation of nano-crystals in the second undercoating layer is not disturbed. According to the composition of the magnetic alloy material in the granular recording medium, there is a case where large perpendicular magnetic anisotropy energy may be obtained when a Ru film is provided right underneath it. In that case, it is especially desirable to apply the second undercoating layer.

Since an alloy undercoating layer of the present invention has a larger lattice size as compared with a conventional Ru undercoating layer, a CoCrPt alloy which contains a lot of Pt, etc. and has a relatively large lattice size is preferable for a magnetic alloy used in a granular recording medium from the viewpoint of lattice matching. However, a magnetic alloy containing a lot of Pt has a large magnetic anisotropy energy, so that a granular recording medium using such a magnetic alloy often requires a larger magnetic field for recording. Then, it is preferable that a granular recording medium consists of a dual layer having different magnetic alloy compositions, and a magnetic alloy having a large lattice size is applied to the lower layer in contact with the alloy undercoating layer, and a magnetic alloy having a relatively small lattice size is applied to the upper layer thereof.

According to the present invention, it becomes possible that grain boundaries are excellently formed and a granular recording medium which has excellent crystallographic orientation in a magnetic alloy part is obtained even in the case of an undercoating layer thinner than a conventional Ru undercoating layer. Therefore, it becomes possible to make a recording with a high signal to noise ratio on a granular recording medium having high recording performance using a large recording field gradient. Therefore, making a magnetic disk apparatus with further increasing recording density is achieved.

Additionally, in the case where the second metal is Cr, an alloy undercoating layer of the present invention consists of Cr elements and a noble metal material both of which have excellent corrosion resistance. Although a perpendicular magnetic recording medium generally has a soft-magnetic underlayer including a lot of Co, Fe, and Ni which have low corrosion resistance at the lower part (substrate side) of the undercoating layer, the corrosion of the soft-magnetic underlayer is remarkably suppressed by covering this soft-magnetic underlayer with the alloy undercoating layer of the present invention. Therefore, a perpendicular magnetic recording medium of the present invention not only has excellent recording performance but also has excellent corrosion resistance under adverse environmental conditions such as high humidity and high temperature, etc. and it contributes to an improvement in the reliability of the magnetic recording apparatus.

### BRIEF DESCRIPTION OF THE DRAWINGS

FIG. 1 is a cross-sectional schematic drawing illustrating a basic structure of a perpendicular magnetic recording medium of the present invention.

FIG. 2 shows the undercoating layer Cr composition dependence of the coercivity Hc of the granular recording layer in magnetic recording media having a PtCr undercoating layer described in embodiment 1.

FIG. 3 shows the undercoating layer Cr composition dependence of the diffraction peak intensity of the magnetic alloy in magnetic recording media having a PtCr undercoating layer described in embodiment 1.

FIG. 4 shows the undercoating layer Cr composition dependences of the signal to noise ratio (SNR) of magnetic recording media having a PtCr undercoating layer described in embodiment 1.

FIG. 5 shows the undercoating layer Cr composition dependence of the coercivity Hc of the granular recording layer in magnetic recording media having various alloy undercoating layers described in embodiment 2.

FIG. 6 shows the Pt composition dependence of the coercivity Hc and the signal to noise ratio (SNR) of granular magnetic recording media when the Cr composition is fixed at 24 atomic % and the compositions of Pt and Pd are changed in a PtPdCr alloy undercoating layer described in embodiment 2.

FIG. 7 shows the undercoating layer V composition dependence of the signal to noise ratio (SNR) of magnetic recording media having a PtV undercoating layer described in embodiment 3.

FIG. 8 shows the additive composition dependence of the X-ray diffraction peak position when Cr and C are added to a Pt undercoating layer in embodiment 3.

FIG. 9 is a schematic drawing illustrating a structure and component parts of a magnetic recording device (HDD).

### DETAILED DESCRIPTION OF THE INVENTION

Hereinafter, the effects brought about by the present invention will be explained referring to drawings based on several embodiments to which the present invention is applied. These embodiments are described in order to illustrate the general principles of the present invention, and the present invention is not intended to be limited to these embodiments.

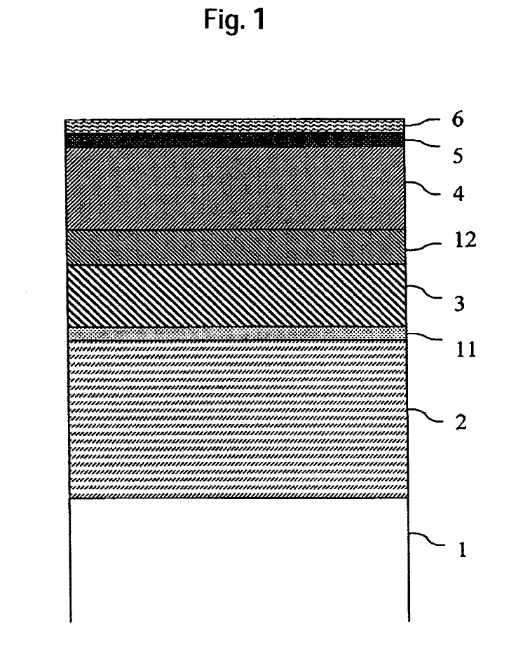

FIG. 1 is a cross-sectional schematic drawing illustrating a perpendicular magnetic recording medium of the present invention. A perpendicular recording medium of the present invention has a structure in which a soft-magnetic underlayer 2, an undercoating layer 3, a magnetic recording layer 4, a protective layer 5, and a lubricant layer 6 are formed, in order, on a non-magnetic substrate 1.

Various substrates with a smooth surface can be used for the non-magnetic substrate 1. For instance, a NiP-plated aluminum alloy substrate and a tempered glass substrate which are currently used for a magnetic recording medium can be used. In addition, a plastic substrate composed of a resin such as polycarbonate, etc. which is used for an optical disk medium can be used. However, with a plastic substrate there are limitations, such as the strength of the substrate itself being small and it being easily deformed at a high temperature, etc.

As the soft-magnetic underlayer 2, a nano-crystalline structured FeTaC, FeSiAl (sendust) alloy, etc. and CoNbZr and CoTaZr alloys which are Co alloys with an amorphous structure are used. The soft-magnetic underlayer 2 is provided to absorb the magnetic leakage flux from the magnetic recording head during use, and the magnetic flux density and the film thickness of the soft-magnetic alloy are designed to achieve this purpose. The appropriate film thickness depends on the structure of the magnetic recording head and its characteristics, but it is assumed to be, striking a balance with the productivity, roughly about 20 nm or more and about 200 nm or less. Moreover, it is also possible that the soft-magnetic underlayer consists of a plurality of layers. Structures are known in which the reading noise caused by the leakage flux from the soft-magnetic underlayer is suppressed by sandwiching a Ru layer between the two layers of the soft-magnetic layers and creating antiferromagnetic coupling and in which the magnetic direction of the soft-magnetic underlayer is pinned, except while recording, by providing an antiferromagnetic material such as Mnlr alloy underneath the soft-magnetic underlayer.

An alloy including a first metal composed of Pt, Pd, or an alloy thereof and a second metal composed of Cr, V, or an alloy thereof is used for the undercoating layer 3. Herein, when the atomic fraction of the first metal is assumed to be A and the atomic fraction of the second metal is assumed to be B, the composition is determined such that the composition of these metals lies in the range 15%<B/(A+B)<30%. As mentioned above, although the film thickness of the undercoating layer 3 is controlled to be 1 nm or more and 20 nm or less in which sufficient crystallographic orientation is obtained and the surface roughness of the undercoating layer does not become too great, a smaller thickness is preferable from the viewpoint of making the recording magnetic field gradient from the magnetic recording head a maximum. A seed layer 11 may be provided between the soft-magnetic underlayer 2 and the undercoating layer 3. The seed layer 11 should not prevent the formation of the fcc crystal structure of the undercoating layer 3 or the perpendicular orientation of the [111] axis, and an amorphous material such as Ta, NiTa, NiTaZr, etc. can be used. Cr, Mo., and W, etc. can be applied in the region of film thicknesses of 2 nm or less where their crystal growth has not started yet. A second undercoating layer 12 composed of Ru or mainly composed of Ru may be provided between the undercoating layer 3 and the magnetic recording layer 4.

In the magnetic recording layer 4 a structure consisting of crystal grains composed of a ferromagnetic material and non-magnetic grain boundaries surrounding them is adopted, and a granular recording medium is used in which the non-magnetic grain boundaries are made of a non-magnetic nonmetal. In order to use it for a perpendicular magnetic recording medium, it is necessary that the ferromagnetic crystalline grains have an easy axis along the direction perpendicular to the film surface. For instance, besides CoPt and FePt alloys and an alloy in which an element such as Cr, Ni, Nb, Ta, and B, etc. are added, a SmCo alloy can be used for the ferromagnetic material, but it is not intended to be limited to these examples. An oxide and a nitride can be used for the non-magnetic nonmetal for the non-magnetic grain boundaries. For instance, oxides or nitrides of Si, Ti, Ta, Mg, Cr, Al, Hf, and Zr are preferable.

In some cases, a thin film with high hardness mainly composed of carbon is used for the protective layer 5. In some cases, furthermore, a fluorinated polymer oil such as a PFPE (perfluoro polyether) oil, etc. is coated on the protective layer 5, as the lubricant layer 6. A method for coating the lubricant layer 6 includes a dip coating technique and a spin coating technique.

Various thin film fabrication techniques which are used for semiconductors, magnetic recording media, and optical recording media can be used for the fabrication of each layer stacked on the above-mentioned non-magnetic substrate 1, except for the lubricant layer 6. As this thin film fabrication technology, a DC magnetron sputtering technique, an RF magnetron sputtering technique, and a vacuum deposition technique are well known. Among these techniques, a sputtering technique in which the deposition speed is relatively high, a high purity film can be obtained independent of material, and both the nano-structure and the film thickness distribution can be controlled by changing the sputtering conditions (sputtering gas pressure and electrical discharge power), is suitable for mass-production. Specifically, when a granular recording medium is deposited, the formation of grain boundaries can be further accelerated by mixing a reactive gas such as oxygen and nitrogen, etc. into the sputtering gas (a reactive sputtering technique).

### Embodiment 1

A tempered glass substrate for a magnetic recording medium was used as a non-magnetic substrate. After being washed, it was introduced in an in-line type sputtering equipment and a multilayer sputtered thin film was formed by using a DC sputtering technique. In order to ensure the adhesion of the multilayer film to the substrate, at first, a 20 nm thick adhesion layer was deposited by using a Ni₆₅Ta₃₅ target. Then, a 50 nm thick soft-magnetic amorphous film was deposited by using a CoTa₃Zr₅ target, a 1 nm thick antiferromagnetic coupling film by using a Ru target, and a 50 nm thick soft-magnetic amorphous film by using a CoTa₃Zr₅ target again, resulting in a triple-layer stacked structure soft-magnetic underlayer being formed. The sputtering Ar gas pressure for each of the above-mentioned layers was controlled to be 1 Pa. Then, a 10 nm thick undercoating layer composed of a PtCr alloy was deposited by discharging a Pt target and a Cr target simultaneously under an Ar gas pressure of 2 Pa, and a 15 nm granular recording layer was deposited by discharging a CoCr₁₂Pt₂₀—SiO₂ (8 mol %) composite sputtering target under an Ar gas pressure of 3.5 Pa. Oxygen with a partial pressure of 1.5% was added to the sputtering gas when the granular recording layer was deposited. Finally, a 5 nm thick protective layer was formed by discharging a carbon target under an Ar gas pressure of 1.5 Pa in which 10% of nitrogen gas was added. After forming a multilayer sputtered thin film, it was taken out from the sputtering equipment, and a PFPE lubricant was coated thereon by using a dip-coat technique, and the protruding portions and foreign material were removed by varnishing the surface. A magnetic recording head could be floated on this magnetic recording medium at a flying height of about 9 mm.

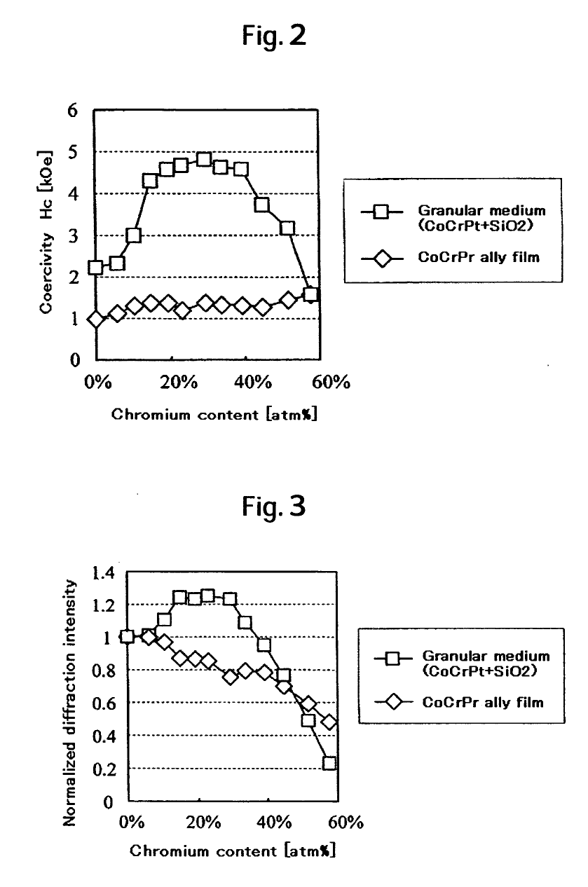

FIG. 2 shows how the coercivity Hc of a magnetic recording medium fabricated according to the above-mentioned procedure changes with respect to the Cr composition of the PtCr undercoating layer. The Cr composition is determined by ESCA (X-ray photoelectron spectroscopy (XPS)) and plotted as an atomic fraction. As a comparison, a result in the case of deposition of an alloy magnetic layer composed of only the CoCrl₂Pt₂₈ alloy is shown in lieu of the aforementioned granular recording layer. In the case of using the granular recording layer, the coercivity started increasing when the atomic fraction of the Cr element was about 8%, and reached a maximum in a region from 15 to 40%, and decreased rapidly when it increased further. On the other hand, in the case of a continuous alloy magnetic layer having no granular structure, the coercivity increases with added Cr element, but a peak in the coercivity could not be observed as seen in the case of a granular recording layer.

X-ray diffraction measurements using a 0-20 scanning technique were carried out for the medium shown in FIG. 2. FIG. 3 shows how the X-ray diffraction intensity measured at the diffraction peak of a CoCrPt magnetic alloy changes with respect to the Cr composition of the PtCr undercoating layer. In the case of a granular recording layer, it is understood that the Cr addition dependence of the X-ray diffraction intensity has the same shape as that of the coercivity. That is, the X-ray diffraction intensity reached a maximum when the amount of added Cr element was about 15 to 30 atomic % or so. Moreover, the diffraction intensity decreased rapidly when the Cr element fraction exceeded 30 atomic % and the crystallographic orientation of the granular recording medium rapidly deteriorated. On the other hand, in the continuous alloy magnetic layer, the X-ray diffraction intensity decreases with increases in the amount of added Cr element.

The reason why the effects of an addition of Cr element are greatly different between the granular magnetic film and the continuous alloy magnetic film can be explained as follows. The crystal grain size of the PtCr alloy undercoating layer decreases with increases in the Cr element content in the PtCr alloy undercoating layer, and, when the amount of added Cr element reaches 15 to 30 atomic %, it comes close to the original grain diameter of the granular recording layer and it becomes an appropriate structure to form the granular structure. If a granular magnetic layer is formed on this alloy undercoating layer, the formation of oxide grain boundaries is accelerated while crystal growth inside magnetic crystal grains improves, resulting in the X-ray diffraction intensity and the coercivity being increased. In the case of a continuous alloy magnetic layer, there is no effect of a nano-structure of the PtCr alloy undercoating layer as mentioned above. The average crystallographic orientation, looking at the whole of the PtCr alloy undercoating layer, deteriorates with increases in the amount of added Cr element, and this effect influences the alloy magnetic layer so as to decrease the X-ray diffraction intensity of the recording layer.

When the amount of added Cr element is less than the aforementioned appropriate range, the grain diameter of the PtCr alloy undercoating layer is greater than that of the recording layer, so that the formation of oxide grain boundaries of the granular magnetic layer does not progress and the crystallinity of the magnetic grains is deteriorated due to the mixing of oxides within the magnetic grains. On the other hand, in the region where Cr element fraction exceeds 30 atomic %, the grain diameter of the PtCr alloy undercoating layer is further decreased and becomes smaller than the original crystal grain size of the granular recording medium, so that the crystallinity of the magnetic crystal grains in the granular magnetic layer is deteriorated, resulting in the X-ray diffraction intensity being decreased. The reason why the coercivity of the granular recording layer maintains a large value even when it exceeds 30 atomic % where the X-ray diffraction intensity is drastically decreased is that the dispersion of the magnetic characteristics (disorder of the magnetic easy-axis direction) is increased by deterioration of the crystallinity of the magnetic crystal grains. The phenomenon whereby the coercivity is increased can be seen here and there in the behavior of magnetic materials when the dispersion of the magnetic characteristics is large. A large dispersion of the magnetic characteristics is an obstacle to high density recording, so that it is not preferable as a magnetic recording medium.

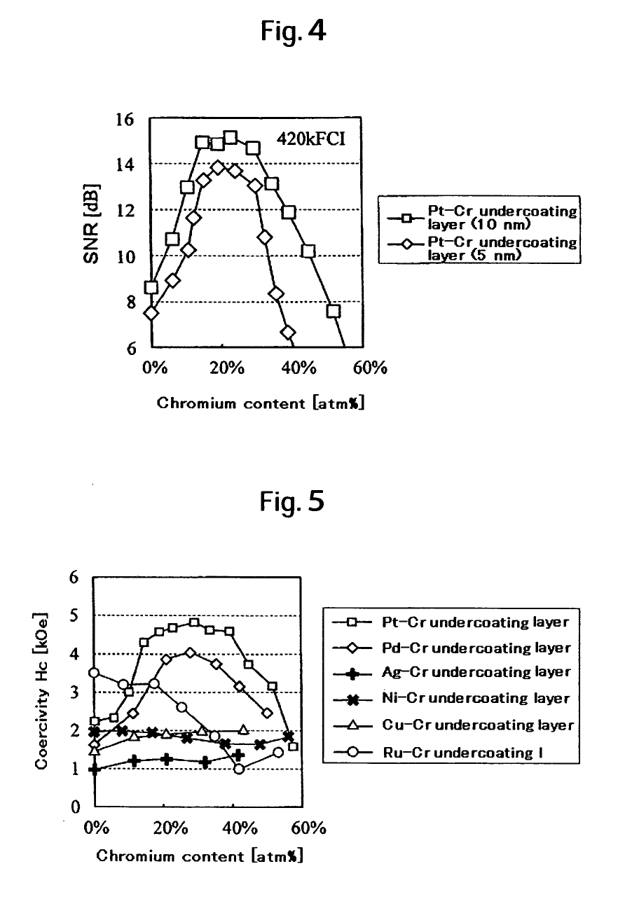

FIG. 4 shows the signal to noise ratio (SNR) of a medium among the perpendicular magnetic recording media shown in FIGS. 2 and 3 to which a granular recording layer is applied when recording at a linear recording density of 420 kFCI is carried out using a single-pole type write head and reading is carried out using a GMR read head. As expected from the aforementioned results, high SNR values could be obtained in the range where the Cr composition of the undercoating layer is 15 atomic % or more and 30 atomic % or less. Moreover, FIG. 4 also shows SNR values in the case when the film thickness of the PtCr alloy undercoating layer is reduced to 5 nm. It is understood that high recording performance can be obtained in the range where the Cr composition of the undercoating layer is 15 atomic % or more and 30 atomic % or less, being independent of the thickness of the PtCr alloy undercoating layer.

It is clear from the above results that grain diameter matching between the undercoating layer and the magnetic recording layer has important meaning when a granular recording layer is applied to the magnetic recording layer, and that magnetic characteristics suitable for the perpendicular magnetic recording medium can be achieved in the range where the Cr composition of the undercoating layer is 15 atomic % or more and 30 atomic % or less in which excellent matching can be achieved in the case of the PtCr undercoating layer. However, a similar result cannot be expected in a magnetic layer which does not have a granular structure.

### Embodiment 2

Embodiment 2 shows the results where the differences of the magnetic characteristics are compared in the case where undercoating layers are fabricated using various materials in lieu of the PtCr alloy undercoating layer described in the embodiment 1 and a material substituted for Pt and Cr is studied. In this embodiment, the recording performance of the medium was evaluated by the SNR value when the linear recording density was assumed to be 420 kFCI, and studies were carried out with the aim of having the SNR value exceed 14 dB when the thickness of the undercoating layer was controlled to be 10 nm.

A tempered glass substrate for a magnetic recording medium was used as a nonmagnetic substrate. After being washed, it was introduced in an in-line type sputtering equipment, and a multilayer sputtered thin film was formed by using a DC sputtering technique. The deposition conditions of each layer except for the undercoating layer are the same as those of embodiment 1. The formation of a protective layer and a lubricant layer and a surface treatment were carried out as in embodiment 1, and a magnetic recording medium was obtained which could read/write by using a magnetic recording head.

FIG. 5 shows the Cr composition dependence of the coercivity of the granular recording layer when various metallic elements are used for making an alloy undercoating layer with the Cr element in lieu of Pt in embodiment 1. The deposition method of the undercoating layer is the same as in embodiment 1, and the thickness of the undercoating layer is controlled to be 10 nm. Except for Pt, the only element showing a tendency to increase the coercivity with added Cr element is Pd, and, in the case of Ag, Ni, and Cu, a coercivity of 2 kOe or less is obtained, even if Cr element is added. In the case of Ru, the coercivity decreased with increases in the amount of added Cr element.

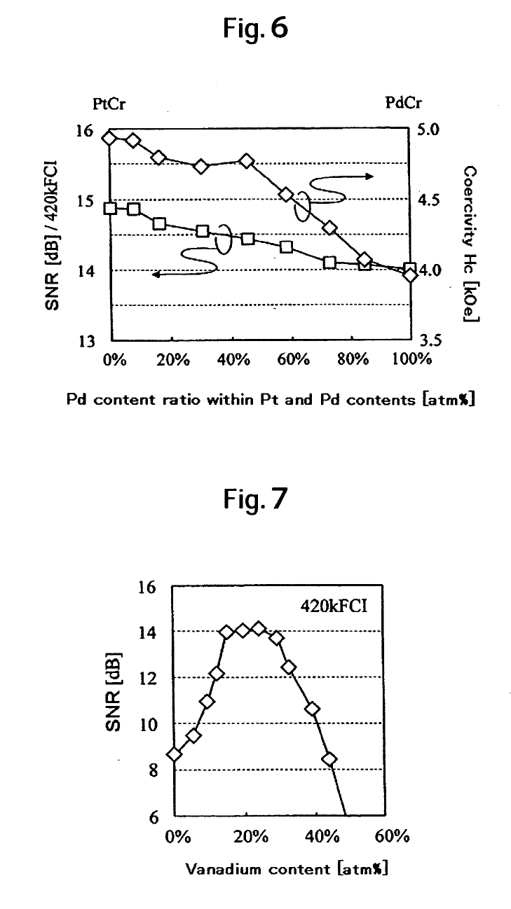

It is understood that the PdCr undercoating layer has a Cr addition dependence similar to that of the PtCr undercoating layer. However, the absolute value of the coercivity is smaller than that of the PtCr alloy. FIG. 6 shows the results of investigating the changes in coercivity of a granular recording layer and the signal to noise (SNR) while reading/writing at a linear recording density of 420 kFCI when the Cr composition is fixed at 24 atomic % and the compositions of Pt and Pd are changed in a PtPdCr alloy undercoating layer. A greater coercivity of the granular recording layer is obtained with increases in the Pt element, which means excellent thermal stability is obtained. Moreover, the greater the Pt element, the higher the SNR, and performance suitable for a high density magnetic recording is obtained. Here, it is thought that, since the melting point of Pt (literature data: 1773° C.) is higher than the melting point of Pd (literature data: 1554° C.), an increase in the Pt element has an advantage where it is easier for the grain diameter of the undercoating layer to become fine. However, the deterioration of the recording performance is in a permissible range (14 dB or more) when a PdCr alloy is used in lieu of PtCr, and Pd has an advantage in terms of material cost, so that a PtPdCr alloy and a PdCr alloy are also potential materials for the undercoating layer.

Furthermore, a case where various Pt alloy materials were used for the undercoating layer in the aforementioned perpendicular magnetic recording medium was discussed. The composition of elements added to Pt and the thickness of the undercoating layer are assumed to be about 20 atomic % and 10 nm, respectively. Table 1 summarizes these undercoating layer materials: the coercivity Hc, the squareness ratio S, the X-ray diffraction peak intensity and the full width at half maximum of the rocking curve Δθ₅₀ of the hcp (002) plane of the CoCrPt granular recording layer, and the SNR at a linear recording density of 420 kFCI.

TABLE 1

| Under- | | | | | |
|---|---|---|---|---|---|
| coating | | | Diffraction | | |
| layer | Coercivity | Squareness | intensity | Δθ50 | SNR |
| material | [kOe] | ratio | [cps] | [deg.] | [dB] |
| Pt | 2.3 | 0.99 | 12900 | 4.4 | 8.5 |
| Pt—Cr20 | 4.8 | 0.99 | 16200 | 4.1 | 14.9 |
| Pt—V20 | 4.6 | 0.99 | 15400 | 4.3 | 14.1 |
| Pt—Ta20 | 2.8 | 0.98 | 10300 | 5.1 | 10.5 |
| Pt—Ti20 | 3.6 | 0.98 | 10200 | 5.2 | 12.1 |
| Pt—W20 | 4.2 | 0.88 | 5800 | 6.8 | 8.8 |
| Pt—C20 | 4.6 | 0.79 | 4600 | 7.3 | 9.5 |

In Table 1, the case when Cr elements are added has the greatest coercivity, diffraction intensity, SNR, and the best crystallographic orientation dispersion, and the case where V is added is next. In the case when all other elements are added, the diffraction intensity of the granular recording layer is lowered, the Δθ₅₀ is increased, and the crystallographic orientation is deteriorated compared with a pure Pt undercoating layer. In the case when Ti and Ta are added, the SNR is superior to the case of a pure Pt undercoating layer but clearly inferior to the case of Cr and V, so that it did not reach the 14 dB which is a target of this study. In the case of these added elements, it is considered judging from the small coercivity that growth of grain boundaries is imperfect. When W and C are added, the squareness ratios are small although the coercivities are large. As is evident from a Δθ₅₀ of 6 degrees or more, it is influenced by a large deterioration of the crystallographic orientation.

It is clear from this result that an addition of Cr or V elements is preferable to make the size of the nano-crystals decrease when they are made into an alloy and maintain the crystal structure of the original fcc structure of Pt. It is difficult to obtain the same effects if Ti, Ta, W, and C, etc, are used in lieu of these elements.

Since characteristics close to a Cr element could be obtained when V elements are added, the V composition dependence of a PtV alloy undercoating layer was studied. The results are shown in FIG. 7. V additions exhibit a behavior similar to Cr additions and a high SNR was obtained in the range from 15 to 30 atomic %. Since Cr and V are adjacent elements in the periodic table of the element, the chemical properties are similar and the crystal structures are the same, so that it is reasonable that V and Cr produce similar effects. However, comparing the SNR between these elements, the one when Cr elements are used shows slightly higher values. As shown in Table 1, it is thought that this is due to deterioration of the original fcc structure of Pt being small and disorder of the crystallographic orientation of the magnetic crystal grains in the granular magnetic layer being small (X-ray diffraction intensity is high and Δθ50 is small) in the case of Cr element additions.

### Embodiment 3

In embodiment 3, perpendicular magnetic recording media fabricated by sandwiching a Ru layer between an alloy undercoating layer of the present invention and a granular recording layer will be described. In this embodiment, the recording performance of the medium was evaluated by the SNR when the linear recording density was assumed to be 420 KFCI and studies were carried out with the aim of having the SNR values exceed 14 dB when the sum of the thicknesses of the first and second undercoating layers was controlled to be 10 nm.

The structure and the manufacturing method up to the soft-magnetic underlayer was the same as those in embodiments 1 and 2, and then a 6 nm thick first undercoating layer and a 4 nm thick second undercoating layer composed of Ru were fabricated under Ar gas pressures of 2 Pa and 3.5 Pa, respectively. Following this, Ar gas with an oxygen partial pressure of 1.5% was introduced at a pressure of 3.5 Pa and a 15 nm thick granular recording medium was deposited by using a CoCr₁₄Pt₁₆—SiO₂ (8 mol %) composite sputtering target. In addition, the formation of a protective layer and a lubricant film and a surface treatment were carried out as in embodiment 1 and a magnetic recording medium was obtained which could read/write by using a magnetic recording head.

Moreover, media were fabricated in which a 1 nm thick Ta seed layer between the undercoating layer and the soft-magnetic underlayer was provided and not provided. The Ar gas pressure while deposition of Ta seed layer was controlled to be 1 Pa.

Table 2 summarizes the first undercoating layer materials of a perpendicular magnetic recording medium fabricated in this embodiment, the presence of a Ta seed layer, the coercivity Hc, the square ratio S, the X-ray diffraction peak intensity and the full width at half maximum of the rocking curve Δθ₅₀ of the hcp (002) plane of the CoCrPt granular recording layer. A sample with the first undercoating layer material of Ru in Table 2 substantially has a 10 nm thick Ru undercoating layer which was a combination of a 6 nm thick first undercoating layer and a 4 nm thick second undercoating layer. However, as mentioned above, the formation conditions for the first undercoating layer and the second undercoating layer are different.

TABLE 2

| First | | | | | | |
|---|---|---|---|---|---|---|
| under- | | | | Diffrac- | | |
| coating | Seed | Coer- | Square- | tion | | |
| layer | layer | civity | ness | intensity | Δθ50 | SNR |
| material | (Ta) | [kOe] | ratio | [cps] | [deg.] | [dB] |
| Ru | Present | 3.8 | 0.98 | 15800 | 4.3 | 11.9 |
| | Not | 3.5 | 0.76 | 4900 | 7.8 | 8.4 |
| | present | | | | | |
| Pt | Present | 4.0 | 0.99 | 14000 | 4.2 | 12.9 |
| | Not | 3.9 | 0.99 | 14000 | 4.1 | 12.8 |
| | present | | | | | |
| Pt—Cr24 | Present | 4.9 | 0.99 | 16400 | 3.8 | 15.4 |
| | Not | 4.8 | 0.99 | 16300 | 3.8 | 15.3 |
| | present | | | | | |
| Pt—C24 | Present | 4.8 | 0.91 | 9900 | 5.4 | 12.6 |
| | Not | 4.3 | 0.91 | 9200 | 5.6 | 12.8 |
| | present | | | | | |
| Ni—Cr24 | Present | 4.9 | 0.98 | 17200 | 4.6 | 11.9 |
| | Not | 4.7 | 0.90 | 6000 | 7.2 | 9.9 |
| | present | | | | | |

The media in Table 2 exhibited different characteristics according to the presence of a Ta seed layer especially in the Ru undercoating layer and the NiCr undercoating layer which were not Pt alloy bases. In the case when a Ta seed layer is not present, it is understood that the diffraction intensity decreased and the Δθ50 increased, and that the crystallographic orientation dispersion increased. The SNR corresponding to this deteriorates remarkably and stays at a small value of 10 dB or less. Thus, an amorphous seed layer such as Ta having a large surface energy is effective to enhance the crystallographic orientation of an undercoating layer thereon. When a Pt alloy is used for the undercoating layer, however, deterioration of the crystallographic orientation and the SNR are very small even in the case where there is no Ta seed layer. This is due to the original crystallographic orientation of a Pt alloy being superior to that of Ru and a Ni alloy.

Although both the Pt undercoating layer and the PtCr alloy undercoating layer have excellent crystallographic orientation, a larger coercivity and higher diffraction intensity were obtained in one in which a PtCr alloy undercoating layer was used. As mentioned in embodiment 1, this is explained by the fact that matching of grain diameters is achieved between the Ru second undercoating layer and the granular recording medium.

In the case of the PtC alloy undercoating layer, although a larger coercivity could be obtained than that of the Pt undercoating layer, the crystallographic orientation was lower than that of other Pt alloy undercoating layers and the SNR became lower than the case of a Pt undercoating layer. This indicates that the crystal lattice of the magnetic nanocrystalline grains in the granular recording medium was disordered by additions of carbon C. According to additional experiments carried out by changing the amount of added carbon C elements, the result where the diffraction intensity decreases with an increase in the C content was obtained, and behavior similar to the case with Cr additions could not be observed.

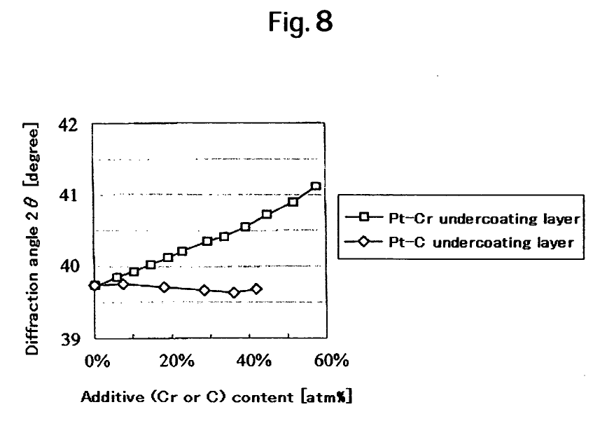

FIG. 8 shows the change in X-ray diffraction peak position when Cr and carbon C are added to a Pt undercoating layer. In the case where Cr elements were added, the diffraction peak position shifted to the wide-angle side gradually and the average lattice size of the alloy crystals was reduced. On the other hand, in the case where carbon was added, the diffraction peak position slightly shifted to the low-angle side and there was a tendency that the average lattice size was broadened slightly. It is considered that, while Pt atoms in a Pt crystal lattice which is relatively large are substituted by Cr atoms to decrease the lattice size, carbon atoms enter the spacing of the Pt crystal lattice to enlarge the spacing of Pt atoms.

In general, since the crystal lattices of CoPt base magnetic alloys and Ru are smaller than that of Pt, lattice matching is improved by decreasing the crystal size of the PtCr alloy and having it approach the lattice size of a CoCrPt alloy and Ru layer in the case of stacking these films, resulting in a reduction in the lattice defect. As a result, the dispersion of easy-axis (c-axis) and the dispersion of magnetic anisotropic energy become smaller, and a magnetic recording medium suitable for a high density magnetic recording can be obtained. The different effects given to the lattice size by additive materials explains one reason why excellent performances was obtained in the case of adding Cr elements in Table 2.

### Embodiment 4

In embodiment 4, perpendicular magnetic recording media fabricated by forming granular recording layers having different magnetic alloy compositions on an alloy undercoating layer of the present invention will be described. In this embodiment, the recording performance of the medium was evaluated by the SNR when the linear recording density was assumed to be 420 kFCI, and studies were carried out with the aim of having the SNR values exceed 14 dB when the sum of the thicknesses of the undercoating layers was set at 10 nm.

The same procedure as in embodiments 1 and 2 were used up to the fabrication of the soft-magnetic underlayer, and, following thereon, a 10 nm thick PtCr24 alloy undercoating layer, a 15 nm thick granular recording layer, and a 5 nm thick carbon nitride protective layer were deposited by using a sputtering technique. Finally, a surface treatment was carried out by forming a lubricant layer, and a magnetic recording medium was obtained which could read/write by using a magnetic recording head. The Ar gas pressure during deposition of the undercoating layer was controlled to be 2 Pa.

Three types of structures were sputtered as the granular recording layers by introducing 3.5 Pa of argon+oxygen gas with an oxygen partial pressure of 1.5%. The structure A is one in which a 15 nm thick granular recording medium was deposited by using a CoCr₁₄Pt₁₆—SiO₂ (8 mol %) composite sputtering target; the structure B is one in which a 15 nm thick granular recording medium was deposited by using a CoCr₁₀Ta₄Pt₂₅—SiO₂ (8 mol %) composite target; and the structure C is one in which a 7.5 nm thick granular recording medium was deposited by using the same target as the structure B and a 7.5 nm thick granular recording medium was subsequently deposited by using the same target as the structure A. Table 3 is a summary of the various characteristics of the manufactured media.

TABLE 3

| Under- | | | | Diffrac- | | |
|---|---|---|---|---|---|---|
| coating | Recording | Coer- | Square- | tion | | |
| layer | layer | civity | ness | intensity | Δθ50 | SNR |
| material | (Ta) | [kOe] | ratio | [cps] | [deg.] | [dB] |
| Pt—Cr24 | Structure | 4.2 | 0.99 | 14200 | 4.7 | 14.3 |
| | A | | | | | |
| | Structure | 6.4 | 0.99 | 16300 | 1.7 | 14.9 |
| | B | | | | | |
| | Structure | 5.0 | 0.99 | — | — | 16.8 |
| | C | | | | | |

Although the SNR of the structures A and B exceeded 14 dB, the structure B has a higher SNR. The structure B is superior to the structure A from the viewpoint of the diffraction intensity and Δθ50 values. It is thought that this is caused by high crystallinity of the granular recording medium. Since the magnetic alloy used for the structure B has greater Pt and Ta compositions than the magnetic alloy used for the structure A, the lattice size of the magnetic alloy of the structure B becomes larger. Since the PtCr alloy undercoating layer of this embodiment had a larger crystal lattice size than the granular recording layers of the structures A and B, it is thought that the lattice matching was improved by using the structure B which has a larger lattice size of the granular layer, and that better crystallinity was obtained in the structure B.

However, although the medium of the structure B showed excellent crystallinity, the amount of increase in SNR relative to the structure A was as small as 0.6 dB. Since the coercivity of the medium of the structure B is as high as 6.4 kOe, the magnetic anisotropic energy of the medium of the structure B is assumed to be very large, and there is a fear that the recording magnetic field generated by the magnetic recording head of this embodiment is not sufficient for recording. Thus, in the structure C, there is an attempt to improve the lattice matching by using the composition of the structure B for the bottom half of the granular recording layer and to decrease the necessary recording magnetic field by using the composition of structure A for the upper half. As a result, an SNR could be obtained which was about 2 dB higher than that of structure B. (The reason why the X-ray diffraction results of the structure C are blank in Table 3 is that the composition of the granular recording medium was changed midway and values which are able to be compared could not be obtained.)

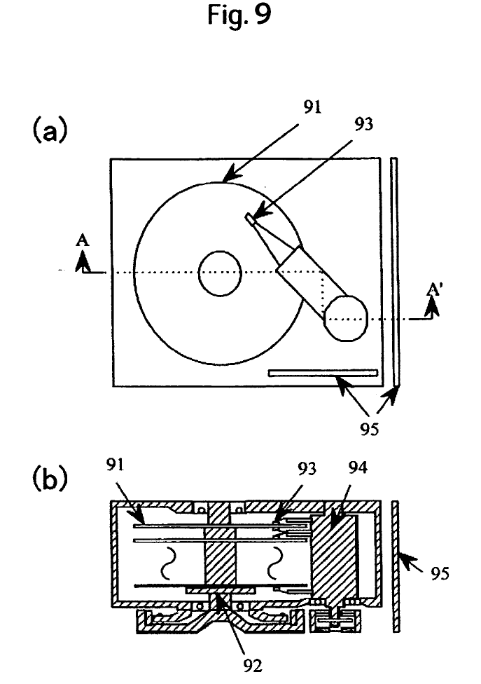

FIG. 9 is a schematic drawing illustrating a structure and component parts of a magnetic recording device (HDD) using a perpendicular magnetic recording medium of the present invention.

This magnetic recording device comprises a magnetic recording medium 91, a motor 92 to rotary-drive the magnetic recording medium 91, a magnetic recording head 93 to perform read/write operations relative to the magnetic recording medium, an actuator 94 to position the magnetic recording head to a desired track position of the magnetic recording medium, and a read/write controller 95. The system configuration itself is well-known. However, a perpendicular magnetic recording medium of the present invention is used for the magnetic recording medium 91. In the magnetic recording head 93, a single-pole-type head is mounted as a write head and a magnetic-resistive head exhibiting giant magneto-resistance effect or tunnel magneto-resistance is mounted as a read head.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A perpendicular magnetic recording medium comprising;
a substrate,
a perpendicular magnetic recording layer having a granular structure consisting of ferromagnetic nanocrystalline grains and non-magnetic grain boundaries surrounding the ferromagnetic nanocrystalline grains,
a soft-magnetic underlayer formed between said perpendicular magnetic recording layer and said substrate,
an undercoating layer formed between said soft-magnetic underlayer and said perpendicular magnetic recording layer,
wherein said undercoating layer includes a first metal selected from the group consisting of Pt and Pd and a second metal selected from the group consisting of Cr and V, and
a composition thereof is 15%<B/(A+B)<30% when an atomic fraction of the first metal is assumed to be A and an atomic fraction of the second metal is assumed to be B.

2. A perpendicular magnetic recording medium according to claim 1, wherein said first metal consists of Pt.

3. A perpendicular magnetic recording medium according to claim 1, wherein said second metal consists of Cr.

4. A perpendicular magnetic recording medium according to claim 1, wherein a thickness of said undercoating layer is about 1 m or more and about 20 nm or less.

5. A perpendicular magnetic recording medium according to claim 1, wherein a second undercoating layer having Ru or an alloy mainly composed of Ru is provided between said undercoating layer and said perpendicular magnetic recording layer.

6. A perpendicular magnetic recording medium according to claim 1, wherein said perpendicular magnetic recording layer comprises at least a lower recording layer and an upper recording layer formed on said lower recording layer, and a crystal lattice size of a ferromagnetic alloy contained in said lower recording layer is greater than a crystal lattice size of a ferromagnetic alloy contained in said upper recording layer.

7. A perpendicular magnetic recording medium comprising;
a substrate,
a perpendicular magnetic recording layer having a granular structure of ferromagnetic nanocrystalline grains and non-magnetic grain boundaries surrounding the ferromagnetic nanocrystalline grains,
a soft-magnetic underlayer formed between said perpendicular magnetic recording layer and said substrate,
an undercoating layer formed between said soft-magnetic underlayer and said perpendicular magnetic recording layer,
wherein said undercoating layer includes a first metal selected from the group consisting of Pt and Pd and a second metal selected from the group consisting of Cr and V, and
a composition thereof is 15%<B/(A+B)<30% when an atomic fraction of the first metal is assumed to be A and an atomic fraction of the second metal is assumed to be B.

8. A perpendicular magnetic recording medium according to claim 7, wherein said first metal consists of Pt.

9. A perpendicular magnetic recording medium according to claim 7, wherein said second metal consists of Cr.

10. A perpendicular magnetic recording medium according to claim 7, wherein a thickness of said undercoating layer is about 1 nm or more and about 20 nm or less.

11. A perpendicular magnetic recording medium according to claim 7, wherein a second undercoating layer having Ru or an alloy mainly composed of Ru is provided between said undercoating layer and said perpendicular magnetic recording layer.

12. A perpendicular magnetic recording medium according to claim 7, wherein said perpendicular magnetic recording layer comprises at least a lower recording layer and an upper recording layer formed on said lower recording layer, and a crystal lattice size of a ferromagnetic alloy contained in said lower recording layer is greater than a crystal lattice size of a ferromagnetic alloy contained in said upper recording layer

13. A magnetic recording device comprising:
a magnetic recording medium, a medium actuator which drives said magnetic recording medium, a magnetic recording head which performs read/write operations to/from said magnetic recording medium, and a head actuator which positions said magnetic recording head to a desired track position of said magnetic recording medium,
wherein said magnetic recording medium has a substrate, a perpendicular magnetic recording layer having a granular structure which consists of ferromagnetic nanocrystalline grains and non-magnetic grain boundaries surrounding the ferromagnetic nanocrystalline grains, a soft-magnetic underlayer formed between said perpendicular magnetic recording layer and said substrate, and an undercoating layer formed between said soft-magnetic underlayer and said perpendicular magnetic recording layer, and wherein
said undercoating layer includes a first metal selected from the group consisting of Pt and Pd and a second metal selected from the group consisting of Cr and V, and a composition thereof is 15%<B/(A+B)<30% when the atomic fraction of the first metal is assumed to be A and the atomic fraction of the second metal is assumed to be B.

14. A magnetic recording device according to claim 13, wherein said first metal consists of Pt.

15. A magnetic recording device according to claim 13, wherein said second metal consists of Cr.

16. A magnetic recording device according to claim 13, wherein a thickness of said undercoating layer is about 1 nm or more and about 20 nm or less.

17. A magnetic recording device according to claim 13, wherein a second undercoating layer having Ru or an alloy mainly composed of Ru is provided between said undercoating layer and said perpendicular magnetic recording layer.

18. A magnetic recording device according to claim 13, wherein said perpendicular magnetic recording layer comprises at least a lower recording layer and an upper recording layer formed on said lower recording layer, and a crystal lattice size of a ferromagnetic alloy contained in said lower recording layer is greater than a crystal lattice size of a ferromagnetic alloy contained in said upper recording layer.
